(19) United States
(12) Patent Application Publication
(10) Pub. No.: US 2023/0309744 A1
(43) Pub. Date: Oct. 5, 2023

(54) Modular and Multi-Functional Grill Devices and Kits

(71) Applicant: Ryan L. Dickerson, Mooresville, NC (US)

(72) Inventor: Ryan L. Dickerson, Mooresville, NC (US)

(21) Appl. No.: 18/123,395

(22) Filed: Mar. 20, 2023

Related U.S. Application Data
(60) Provisional application No. 63/362,237, filed on Mar. 31, 2022.

(51) Int. Cl. A47J 37/07; A47J 37/06

(52) U.S. Cl. CPC A47J 37/0763; A47J 37/0704; A47J 37/0786; A47J 37/067; A47J 2037/0777

(57) ABSTRACT

A modular and multi-functional grill device which includes a grate with legs attached thereto, a cover, and a handle. The legs are pivotally configured and reversibly secured at a plurality of positions to define a height of the grate relative to a heat source. The cover may be reversibly attached to the grate in a plurality of configurations for a plurality of uses, such as a tray for holding fuel for combustion, a serving platter, a windscreen to protect from weather elements, or a griddle. Finally, the handle may be reversibly attached to the grate, cover, or both and thus used to move/hold the grate and/or cover. The handle is also used to reversibly secure the grate to the cover when the grill device is in a storage or transport configuration.

### FIELD

This disclosure relates to modular grill devices that may be configured for use as a standalone grill, a windscreen-protected grill, a griddle grill, and a fire pit grill. These different configurations utilize different ways of connecting and configuring a grate, a cover, and a handle of the presently disclosed grill device.

### BACKGROUND

Many individuals enjoy a grill for cooking when outdoors, for example, when at a picnic, a camping trip, a hiking trip, a trip to the beach, etc. Pre-existing grills are generally larger and difficult to store in vehicles and transport to a recreational site for use. These grills are bulky and generally fixed in size, and as such, are not able to be made more compact for storage or transport. In addition, these grills are often only configured for one mode of use with a certain fixed set of components which generally are not able to be reconfigured for other or alternative configurations and uses. As a result, if an individual wants to configure a pre-existing grill for making a sauce, then a saucepan would be required, which would be a separate component and would increase the bulk and difficulty transporting all the components desired for the grilling activity even further. Further, pre-existing grills are hard to manipulate by a user, for example, moving the grill over an outdoor fire to hotter spots, moving the grill and food on it away from flareups, or taking the grill altogether off the fire when done cooking/grilling are hard, or impossible, to do because the grill is very hot, and this sometimes creates dangerous situations. The presently disclosed grill device solves these deficiencies by providing an elongated handle which can be reversibly and securely attached to the grill/grate, thus allowing the user to manipulate the grill/grate as desired.

Accordingly, there is a need for modular and multi-functional grill devices and kits that enable a user to easily store the grill device when not in use and to transport the grill device to a desired site for recreational use, and which may be configured into a plurality of configurations for a plurality of uses. The present invention addresses this unmet need.

### SUMMARY

This disclosure provides improved grill devices and kits that include a grate, a cover, and a handle. The grate, the cover, and the handle are reversibly connectable to each other to configure the grill device in a compact configuration for storage or transport and are able to be rearranged or reconfigured to configure the grill device for any of a plurality of use configurations. Exemplary use configurations include a standalone configuration, a windscreen configuration, a griddle configuration, and a fire pit configuration. In various embodiments, a plurality of legs is hingedly, or pivotally, attached to the grate and the legs may be secured at a number of angles and positions, relative to the grate or mesh, to secure the grate at any of multiple desired heights over the ground or fire thereunder. The height of the grate relative to the ground may be adjusted to help control the degree of heat applied to food being cooked on the grate.

In some embodiments, the presently disclosed grill device, the grill device comprises a substantially rectangular grate designed for grilling food thereon, a substantially rectangular cover, the cover comprises a substantially flat base with side walls which extend upward and around an outer perimeter of the base, a handle, the handle comprises an elongated rod which comprises a first end and a second end, wherein the first end and the second end each comprise a hook, wherein the grate is designed to fit in the cover when positioned on the flat base.

In some embodiments, the grate comprises a substantially rectangular grate frame and a substantially rectangular mesh designed for grilling food thereon.

In some embodiments, the grate frame comprises a plurality of legs, side walls along the long sides of the substantially rectangular grate frame, side walls along a central portion of each of the short sides of the substantially rectangular grate frame, four pivot locks each positioned in a corner of the grate frame, four substantially flat corner braces each positioned in a corner of the grate frame, and wherein each corner brace has a top side and a bottom side.

In some embodiments, the mesh is designed for removable fit in the grate frame when positioned upon the top side of the corner braces.

In some embodiments, the legs are pivotally attached to the pivot locks.

In some embodiments, the grate frame comprises two U-shaped legs, and wherein each end of the U-shaped leg is pivotally attached to a pivot lock positioned on a corner on each end of a short side of the substantially rectangular grate frame.

In some embodiments, each pivot lock comprises a plurality of ridges which define grooves therebetween, wherein a user can pivot each leg as desired, and reversibly secure it, in a chosen groove, and wherein each groove defines a pre-determined configuration of the leg pivotally attached to the pivot lock.

In some embodiments, an outward spring force pushes the two parallel portions of each the U-shaped leg away from each other, and wherein to pivot the leg to a chosen groove, a user presses the two parallel portions of the U-shaped leg towards each other, thus decreasing the distance between them and allowing them to be passed over ridges as required and be securely and reversibly positioned in a groove chosen by the user.

In some embodiments, the legs can be reversibly secured in a plurality of pre-determined configurations, wherein the pre-determined configurations include a storage/transport configuration, a first use configuration, a second use configuration, and a third use configuration.

In some embodiments, the storage/transport configuration the legs are proximal to, and substantially parallel with, the bottom side of the corner braces, wherein in the first use configuration the legs are at substantially 90 degrees angle in relation to the bottom of the corner braces, wherein in the second use configuration the legs are at substantially 135 degrees angle in relation to the bottom of the corner braces, and wherein in the third use configuration the legs are at substantially 180 degrees angle in relation to the bottom of the corner braces.

In some embodiments, the cover comprises two U-shaped handles, each handle positioned on the outside of the side wall of a short side of the substantially rectangular cover, wherein when the cover is placed upon the grate and the short sides of the cover are above the short sides of the grate, a user can securely and reversibly position the handles around the side walls of the short sides of the grate frame and thus reversibly securing the cover to the grate.

In some embodiments, the side wall along a first long side of the substantially rectangular grate frame comprises two clips, wherein a first clip is positioned substantially at one end of the said side wall and a second clip is positioned substantially at a second end of the said side wall.

In some embodiments, a user can reversibly secure the cover to the grate frame in a windscreen configuration, wherein in a windscreen configuration the substantially flat base of the cover is in an upright position relative to the mesh positioned in the grate frame, and wherein in the windscreen configuration one of the cover's handle is reversibly attached to the first clip and the cover's other handle is reversibly attached to the second clip.

In some embodiments, the side wall along a second long side of the substantially rectangular grate frame comprises an opening, wherein the opening is designed to receive the hook positioned on either the first end or the second end of the handle, and wherein when the said hook is inserted to the said opening the grate frame is reversibly and securely attached to the handle.

In some embodiments, each side wall of each of the two short side of the cover comprises a centrally positioned opening, and wherein each side walls of the short sides of the grate frame comprises a centrally positioned opening, and wherein said openings are designed to receive the hook positioned on either the first end or the second end of the handle, and wherein when the grate frame is positioned inside the cover such that the short sides of the cover are proximal to the short sides of the grate, said openings of the grate frame and cover on each said short sides overlap.

In some embodiments, the grill device is in a compact/transport configuration and wherein when in a compact/transport configuration the grate is positioned inside the cover within the perimeter of the cover's side walls; and wherein the handle reversibly secures the grill device is in a compact/transport configuration by a reversible attachment of the hook on the first end of the handle to the overlapping openings of the grate frame and cover on one side and a reversible attachment of the hook on the second end of the handle to the overlapping openings of the grate frame and cover on the other side.

In some embodiments, the hook on the second end of the handle is a spring-operated hook, wherein when a user can slide the spring-operated hook in the direction of the second end of the handle and away from the first end, the distance between the hook on the first end of the handle and the spring-operated hook increases.

In some embodiments, a user configures the grill device to a compact/transport configuration and wherein after reversibly attaching the hook of the first end of the handle to the openings of the grate frame and cover on one side of the grill device, a user uses the spring-operated hook on the second end of the handle to attach the handle easily and reversibly to the openings of the grate frame and cover on the other side of the grill device.

Various objects, features and advantages of the present invention will become apparent from the following detailed description taken in conjunction with the accompanying drawings.

### BRIEF DESCRIPTION OF THE DRAWINGS

Although the characteristic features of the invention will be particularly pointed out in the claims, exemplary implementations of the invention and manners in which they may be made and used may be better understood after a review of the following description, taken in connection with the accompanying drawings, wherein like numeral annotations are provided throughout.

FIG. 1 shows a perspective view of an embodiment of a grate of a grill device.

FIG. 2 shows a perspective view of an embodiment of a grate, a cover, and a handle of a grill device.

FIG. 3 shows a perspective view of the cover of a grill device based on the embodiment shown in FIG. 2.

FIG. 4 shows a perspective view of the cover of the grill device based on the embodiment shown in FIG. 2, wherein the cover is attached to the grate and configured for use as a griddle.

FIG. 5 shows a perspective view of the cover of the grill device based on the embodiment shown in FIG. 2, wherein the cover is attached to the grate and configured for use as a windscreen.

FIG. 6 shows a perspective view of the cover of the grill device based on the embodiment shown in FIG. 2, wherein the cover is positioned below the grate and configured for use as a standalone grill.

FIG. 7 shows a perspective view of the grate of the grill device based on the embodiment shown in FIG. 1, wherein the grate is positioned above a fire pit and configured for use as a fire pit grill.

FIG. 8 shows a perspective view and an inset of attachment of the handle to the grate; the handle and grate depiction based on the embodiment shown in FIG. 2.

FIG. 9 shows a perspective view of the grate of the grill device based on the embodiment shown in FIG. 1, with a plurality of legs being adjustable between a plurality of configurations.

FIG. 10 shows a perspective view of insertion of the grate into the cover; the cover and grate based on the embodiment shown in FIG. 2

FIG. 11 shows a perspective view of attachment of the handle to the cover to secure the grate therein; the cover, grate, and handle based on the embodiment shown in FIG. 2.

FIG. 12 shows a perspective view of another embodiment of the presently disclosed grill device, wherein the grill device is in a storage configuration.

FIG. 13 shows a perspective view of the presently disclosed grill device based on the embodiment shown in FIG. 12, wherein the grill device is in a disassembled configuration.

FIG. 14A shows a perspective view of the presently disclosed grate based on the embodiment shown in FIG. 12, wherein the legs are secured in position 3″.

FIG. 14B shows a perspective view of the presently disclosed grate based on the embodiment shown in FIG. 12, wherein the legs are secured in position 3″′.

FIG. 14C shows a perspective view of the presently disclosed grate based on the embodiment shown in FIG. 12, wherein the legs are secured in position 3′ and the grate is configured for use as a fire pit grill.

FIG. 14D shows a bottom perspective view of the presently disclosed grate and handle based on the embodiment shown in FIG. 12, wherein the legs are secured in position 3″ and the grate is attached to the handle.

FIG. 14E shows a perspective partial view of the presently disclosed grate based on the embodiment shown in FIG. 12, depicting a leg securement mechanism.

FIG. 14F shows a perspective view of the presently disclosed grate and handle based on the embodiment shown in FIG. 12, wherein the legs are secured in position 3″ and the grate is attached to the handle.

FIG. 14G shows another bottom perspective view of the presently disclosed grate and handle based on the embodiment shown in FIG. 12, wherein the legs are secured in position 3″ and the grate is attached to the handle.

FIG. 14H shows a perspective view of the cover of the grill device based on the embodiment shown in FIG. 12, wherein the cover is attached to the grate and configured for use as a windscreen.

FIG. 14I shows another perspective view of the cover of the grill device based on the embodiment shown in FIG. 12, wherein the cover is attached to the grate and configured for use as a windscreen.

FIG. 14J shows a perspective view of the cover of the grill device based on the embodiment shown in FIG. 12, wherein the cover is positioned below the grate and configured for use as a standalone grill.

FIG. 14K shows a perspective view of the cover of the grill device based on the embodiment shown in FIG. 12, wherein the cover is attached to the grate and configured for use as a griddle.

FIG. 14L shows a perspective view of the cover of the grill device based on the embodiment shown in FIG. 12, wherein the cover is positioned top-side-down on the grate.

FIG. 15A shows a perspective to view of the handle based on the embodiment shown in FIG. 12.

FIG. 15B shows a perspective to view of the handle based on the embodiment shown in FIG. 12.

FIG. 15C shows a partial section view of the handle based on the embodiment shown in FIG. 12.

### DETAILED DESCRIPTION

Reference is made herein to the attached drawings. Like reference numerals may be used in the drawings to indicate like or similar elements of the description. The figures are intended for representative purposes, are not drawn to scale, and should not be considered limiting.

Unless otherwise defined herein, terms and phrases used in connection with the present disclosure shall have the meanings that are commonly understood by those of ordinary skill in the art.

Where a reference is made to a singular noun, whether with or without use of an indefinite or definite article (e.g., “a”, “an”, or “the”), this includes a plural of that noun unless something else is specifically stated. Furthermore, the terms first, second, third, and the like in the description and in the claims, are used for distinguishing between elements and not necessarily for describing a sequential or chronological order. It is to be understood that the terms so used are interchangeable under appropriate circumstances and that the implementations of the disclosure described herein are capable of operation in other sequences than described or illustrated herein.

As used herein, the term “about” refers to the usual error range for the respective value readily known to the skilled person in this technical field. Reference to “about” a value or parameter herein includes and describes implementations and embodiments that are directed to that value or parameter per se.

As used herein, the terms “attachable”, “connectable”, and “adjustable”, and other terms that may indicate an ability of an element to have a property or characteristic as part of a state of the element, include states of the element in which it has the property or characteristic (e.g., is attachable and is attached) as well as states of the element in which it does not have the property or characteristic (e.g., is attachable but is not attached), unless something else is specifically stated. If an element is described as having a property or characteristic (e.g., is attached), this includes elements that may conditionally have the property or characteristic (e.g., may be conditionally attached) as well as elements that may unconditionally have the property or characteristic (e.g., may be unconditionally attached), unless something else is specifically stated.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide. For example, when using the term “substantially” herein it may be a value of at least 50%, at least 60%, at least 70%, at least 80%, at least 90%, or at least 99%, or any amount or range therebetween.

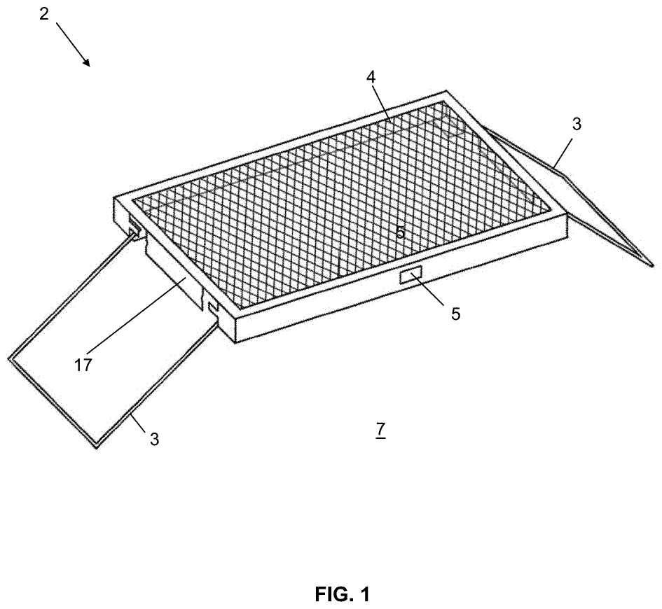

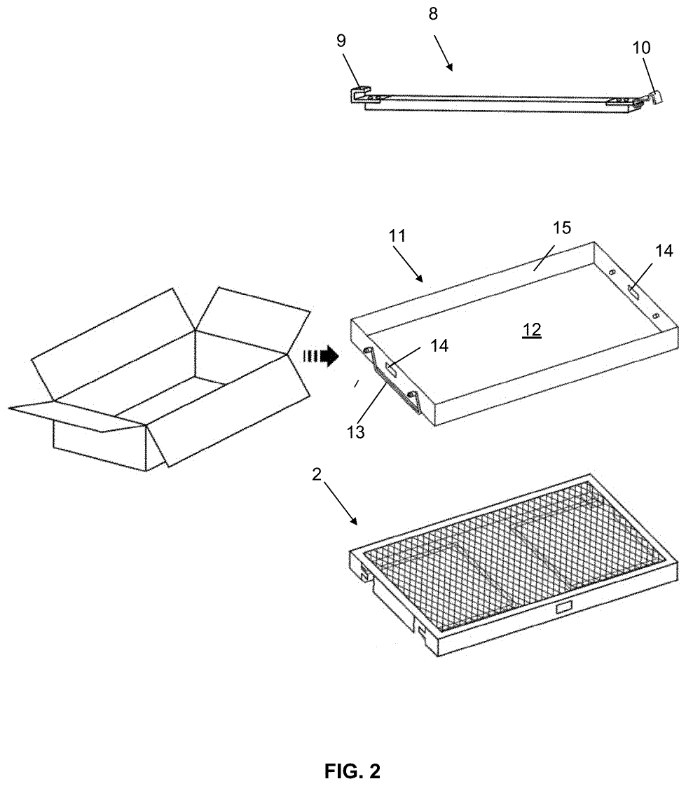

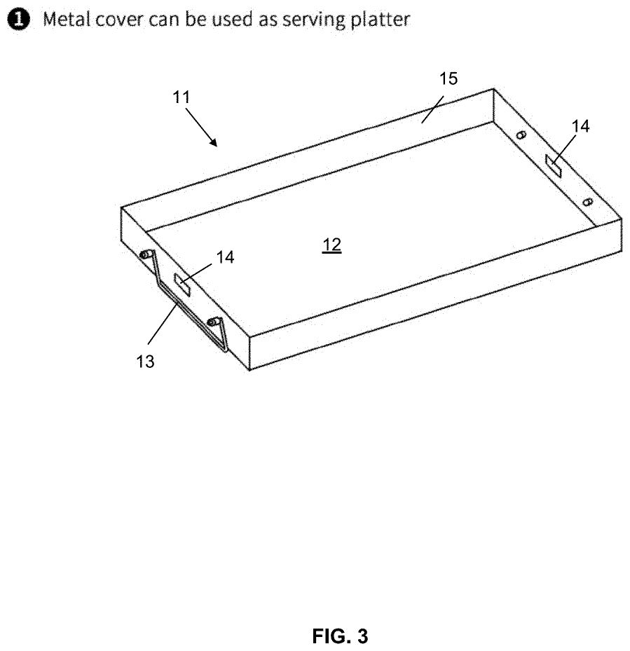

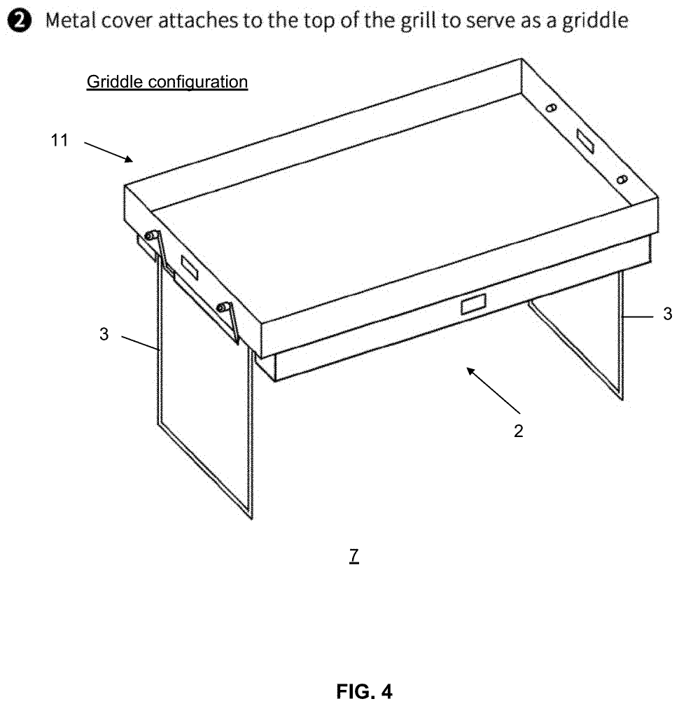

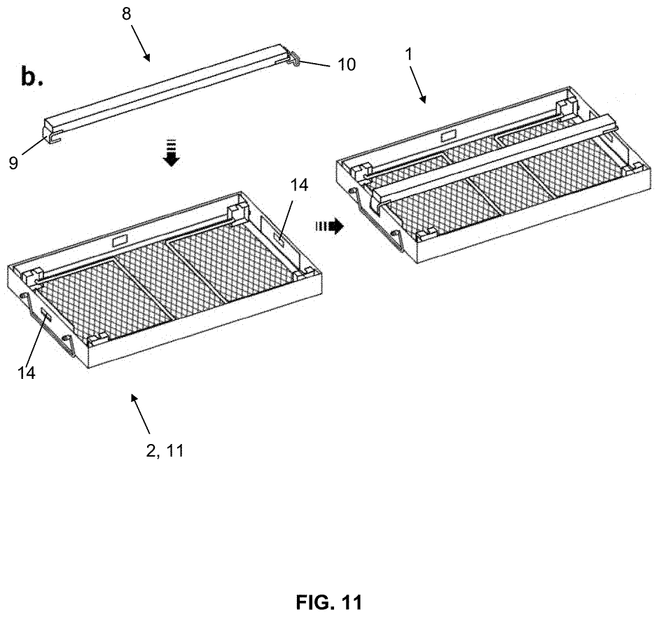

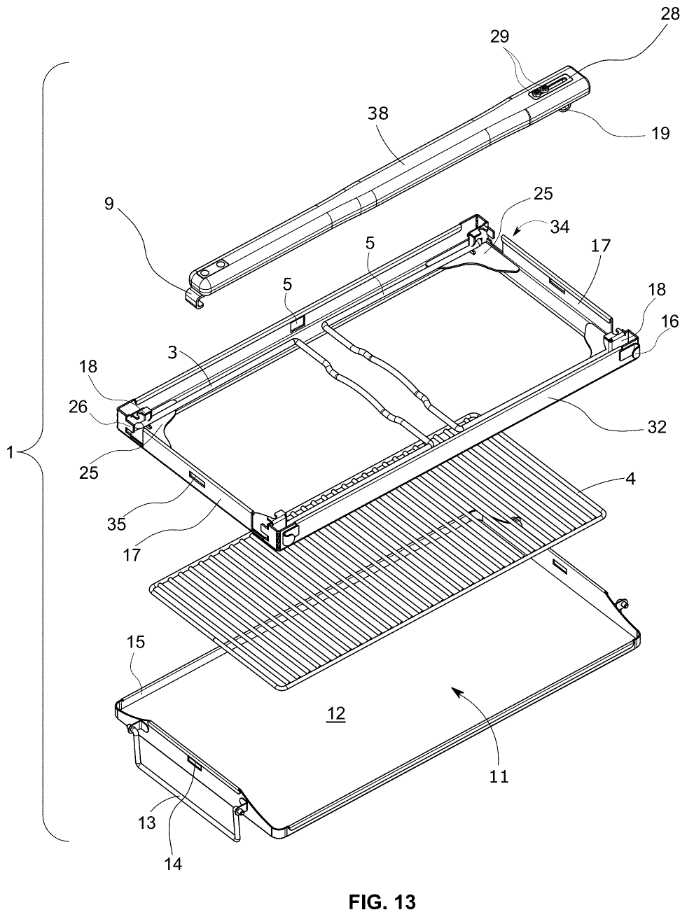

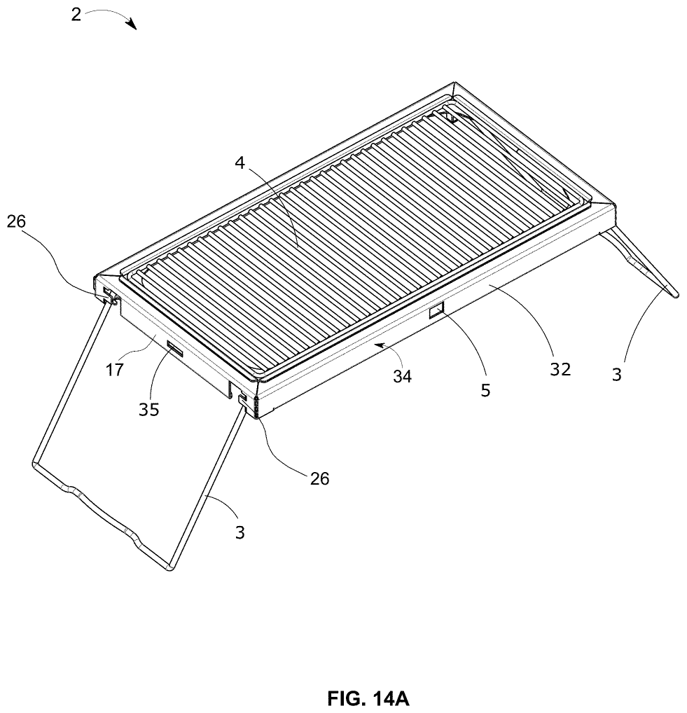

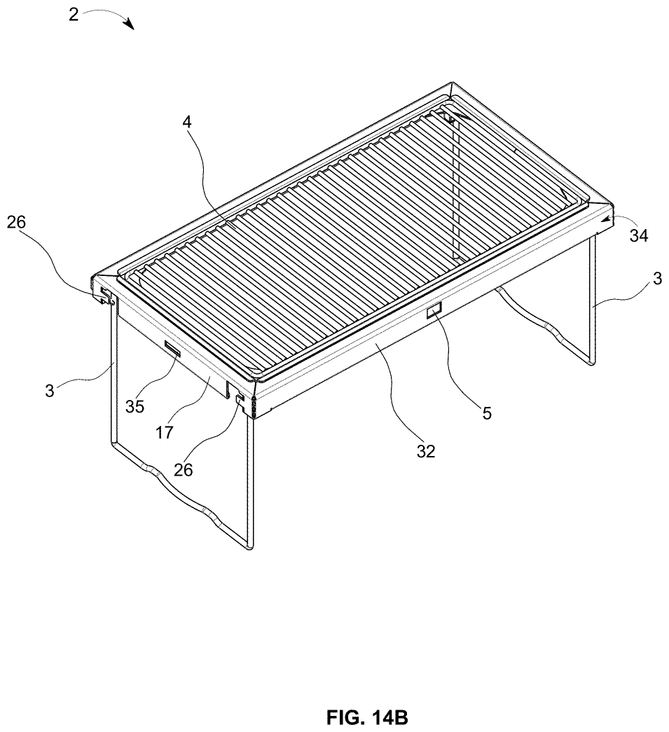

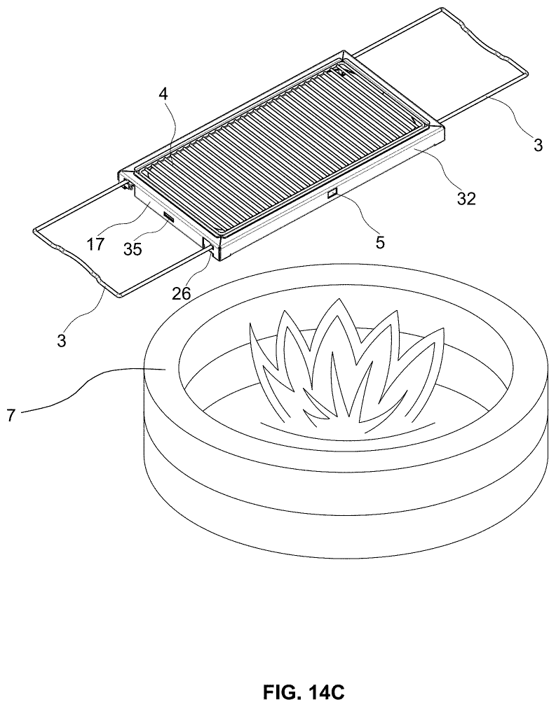

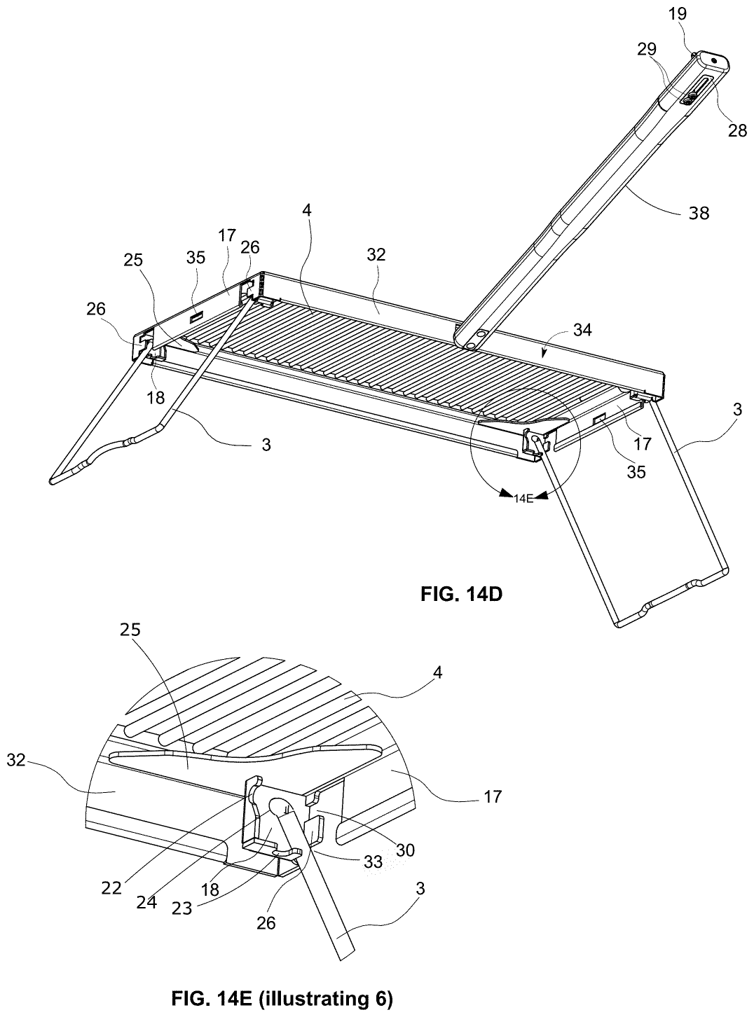

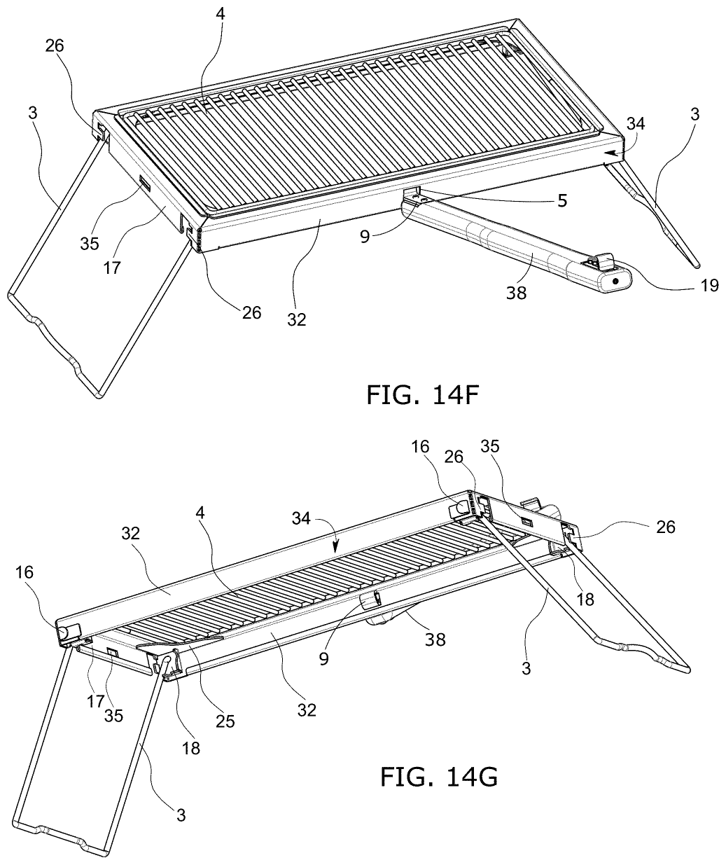

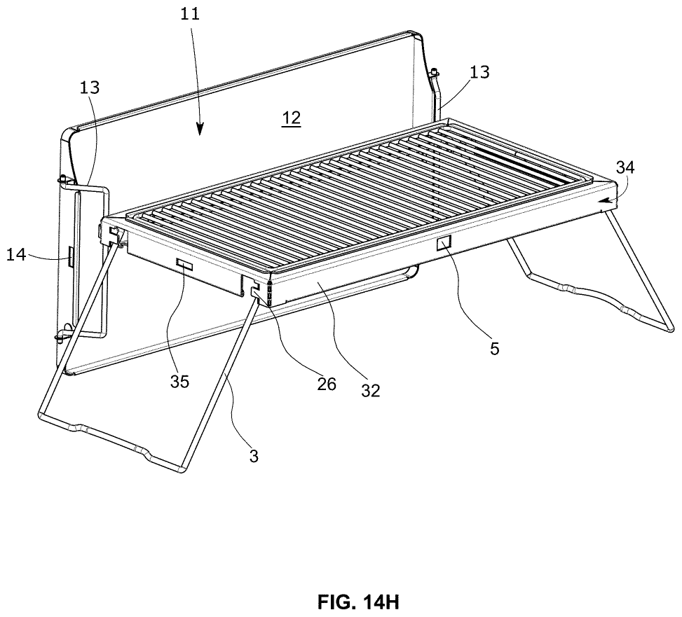

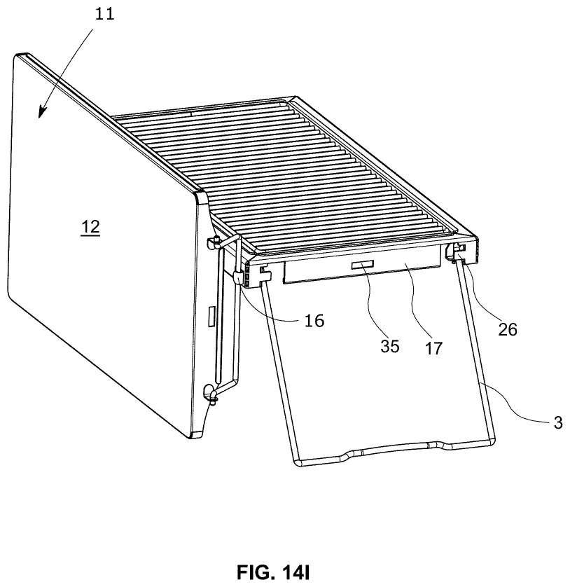

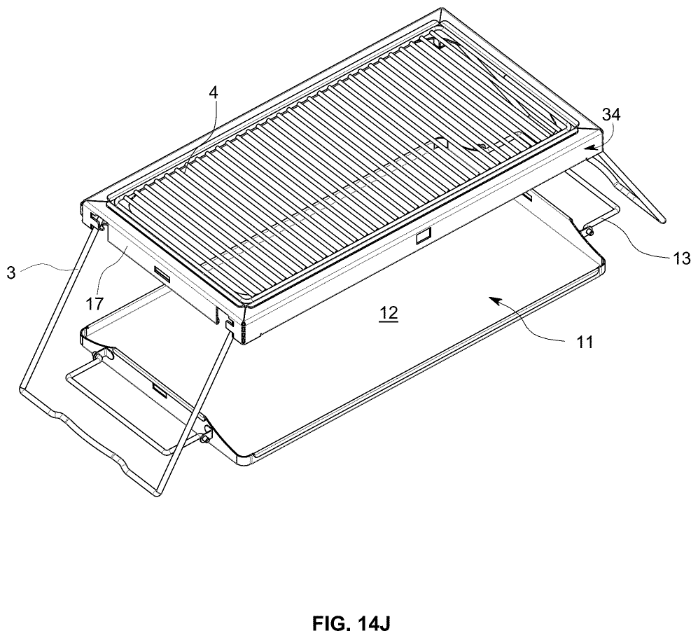

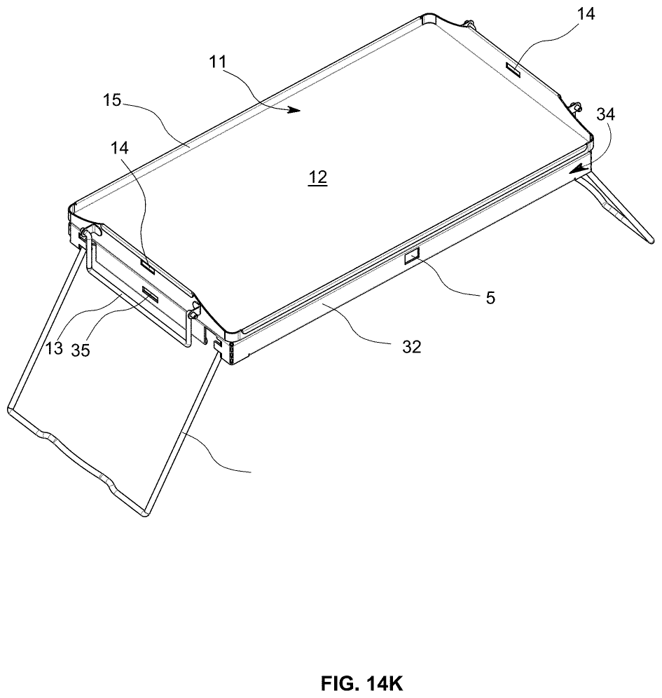

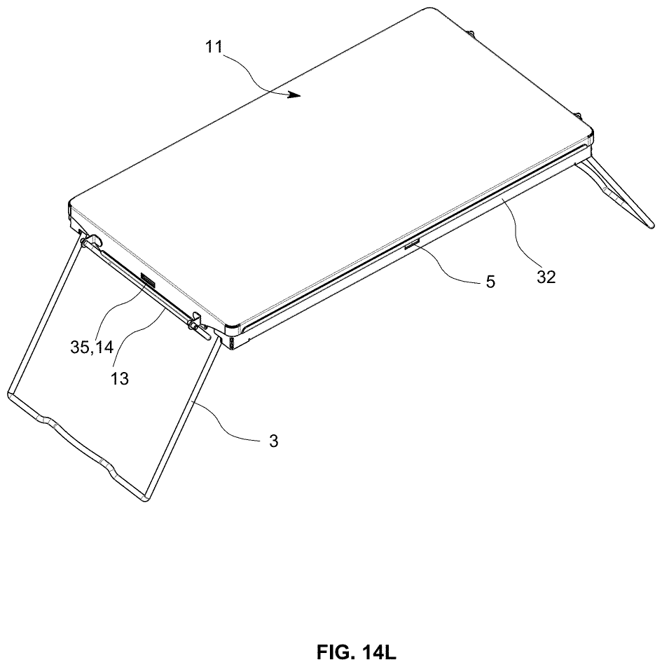

Referring now to FIGS. 1-7, there are shown several perspective views of an embodiment of the presently disclosed grill device 1 and components thereof including a grate 2, a cover 11, and a handle 8. The grate 2, the cover 11, and the handle 8 can be reversibly attached to each other to configure the grill device 1 in a compact configuration (grill device 1 of FIG. 11) useful for storage or transport. The grate 2, the cover 11, and the handle 8 may be rearranged or reconfigured to configure the grill device 1 for a plurality of use configurations. In the embodiment depicted in FIGS. 1-7, the grate 2 includes a grate handle opening 5 for receiving a handle hook 9 therein, grip ridges 17 (also referred to herein as side walls 17) for receiving grips 13 of the cover 11 thereover for securing the cover 11 to the grate 2. Securing the cover 11 to the grate 2 may be used as part of a griddle configuration (see FIG. 4) and a storage/transport configuration (FIG. 11). The grate 2 includes a plurality of legs 3 that are adjustable relative to a mesh 4 of the grate 2 and reversibly securable in a plurality of positions and configurations using a leg securement mechanism 6 (depicted in FIG. 14E). The grate's handle opening 5 enables a user to grip, move, and manipulate the grate 2, even when it is hot from being over a fire, using the handle 8. In some embodiments, the handle 8 of the grill device 1, includes an elongated rod 38 which includes a hook 9 and an angled hook 10 on a first end and a second end thereof, respectively. The grill device 1 comprising the grate 2, cover 11, and handle 8 may be configured in a compact configuration as illustrated in at least FIG. 11 and conveniently boxed (FIG. 2) for delivery to consumers, for example as a grill device kit, or for transport by a user.

Securement of the legs 3 with the leg securement mechanism 6 (depicted in FIG. 14E) enables adjustment of the height/distance from of the mesh 4 (and, if applicable, the cover 11), relative to a fire, to be controllably defined. In this manner, the degree of heat applied to food on the mesh 4, or otherwise on the grate 2 (e.g., as in the use of the cover 11 as a griddle) may be controllably adjusted and defined for improved cooking of the food. The adjustment of the legs 3 and the securement of the legs 3 in place with the leg securement mechanism 6 may also define the use configuration (e.g., a standalone configuration, a windscreen configuration, a griddle configuration, a fire pit configuration, etc.).

In the shown embodiment, the cover 11 includes a base 12 with a ridge/side walls 15 that extends upward around an outer perimeter of the base 12, and which enables the cover 11 to be used to hold sauces or to cook delicate foods, such as fish or bread, when the cover 11 is positioned over the grate 2 and configured for the griddle configuration (see FIG. 4). The cover 11 also includes a cover handle opening 14 for receiving the handle hook 9 therein, so that a user can grip, move, and manipulate the cover 11, even when it is hot from being over a fire, using the handle 8. The cover 11 may be used as a serving platter, for example, as part of a campsite or a beach cookout.

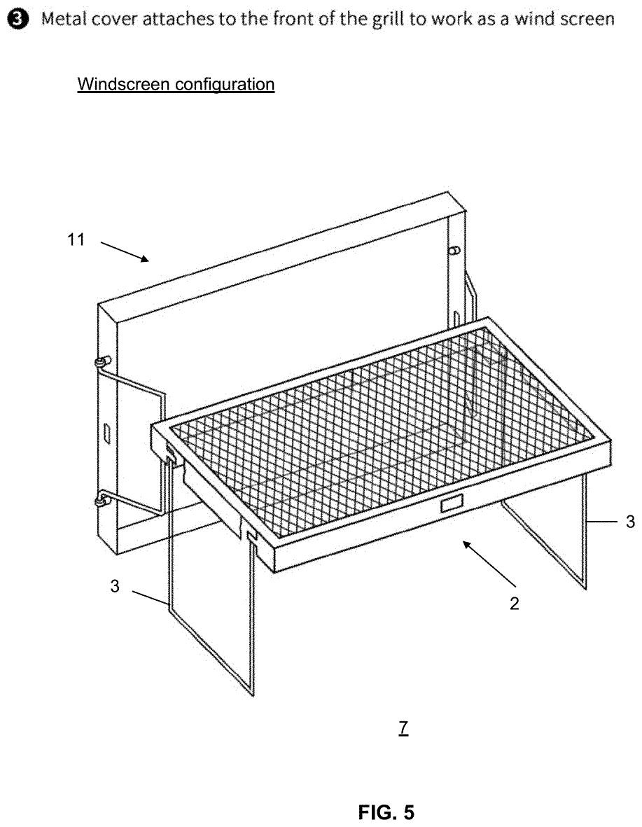

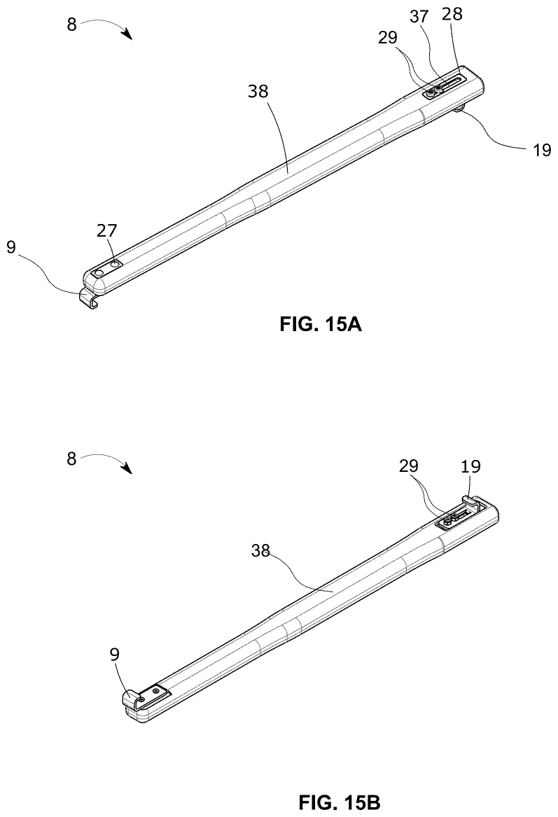

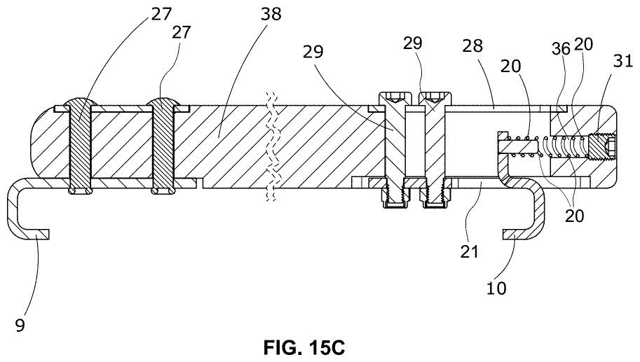

In a windscreen configuration (see FIG. 5), the grips 13 are reversibly secured with clips 16 (see FIG. 15), such that the cover 11 is secured in an upright configuration relative to the mesh 4. The cover 11 acts to block wind, rain, etc. and prevent weather elements from extinguishing the fire or from displacing heat generated from the fire. In this manner, the grill device 1 may be used with the windscreen functionality to maintain use even in the presence of high winds or inclement weather. Additionally, the grips 13 of the cover 11 may be pivoted downward (away from the base) and when the cover 11 is placed on a surface in that configuration, used to elevate the cover 11 above the surface. Such a surface may include a temperature-sensitive surface, thus a potentially hot cover 11 does not melt or damage the temperature-sensitive surface. In this manner, the cover 11 may be used as a heating tray and/or a serving tray for a meal or an event.

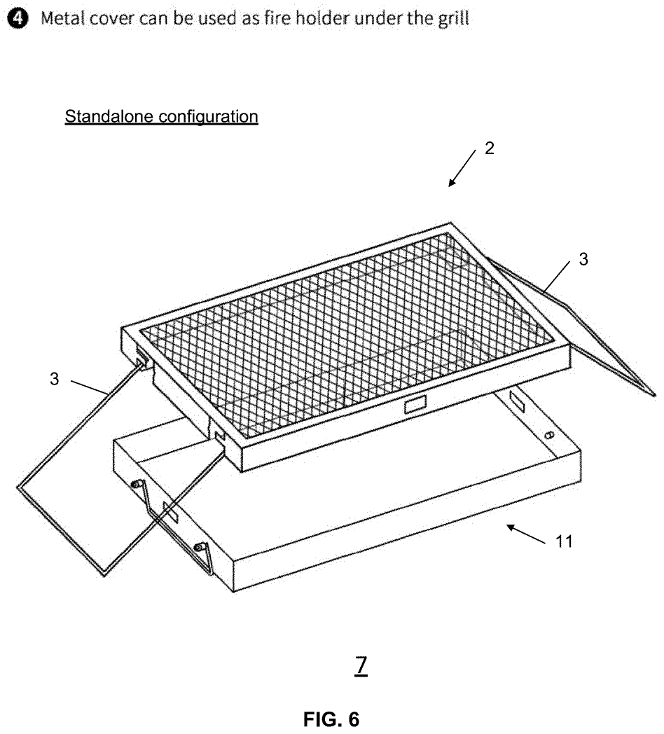

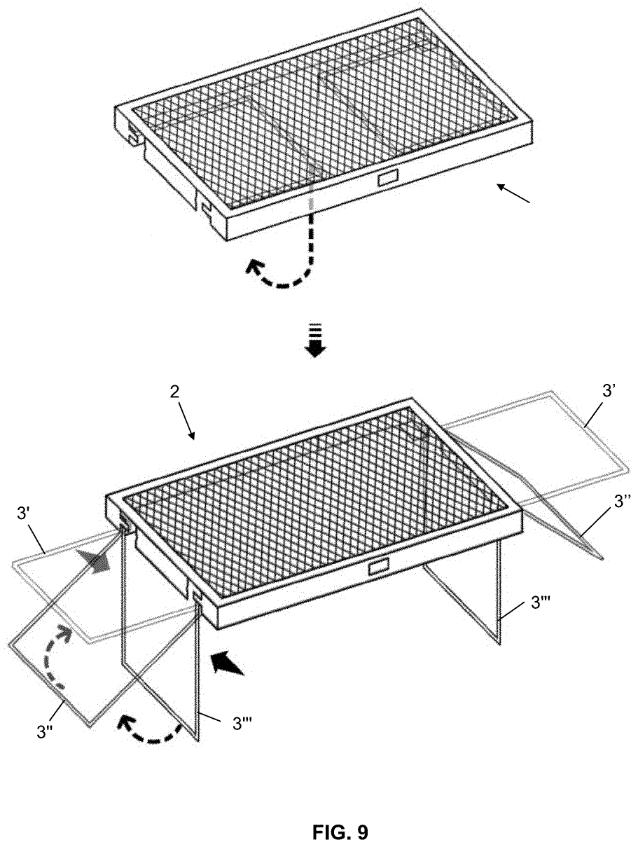

In some standalone configurations (see FIG. 6), the cover 11 may be used to hold fuel (e.g., wood, wood pellets, charcoal, etc.) therein and in this configuration, the legs 3 may be secured in a 3″ (FIG. 9) position to be placed on either side of the cover 11. In this manner, the grill device 1 may not need a separate source of heat, for example, as may be provided from a fire pit or ground fire.

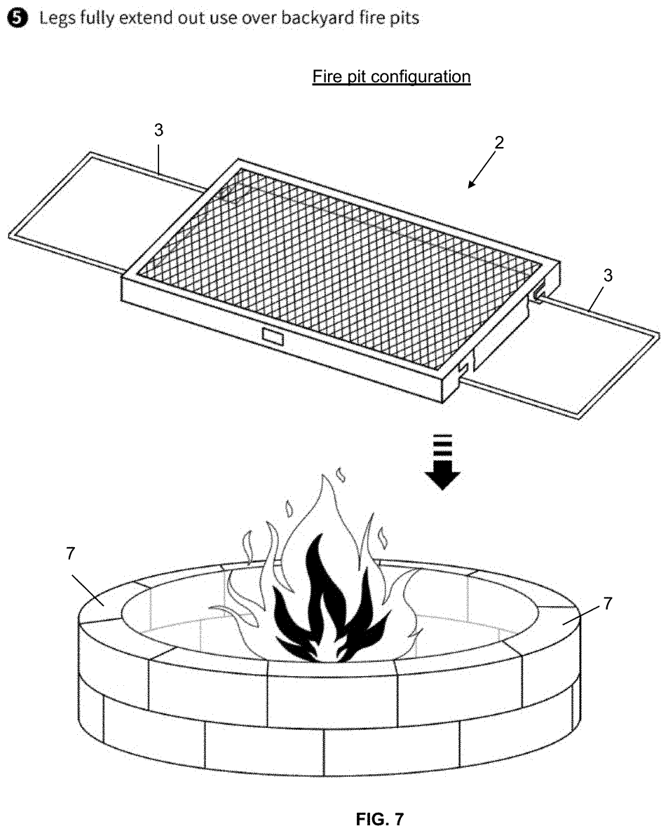

In a fire pit configuration (see FIG. 7), the legs 3 may extend outward horizontal relative to the mesh 4 (position 3′, also referred to herein as a third use configuration, FIG. 9), and may rest on a structure 7 of a fire pit, e.g., a fire pit wall 7, such that the grill device 1 rests over the fire to cook food on the mesh 4. In instances where the size of the fire pit permits, the legs 3 may be adjusted to another position, such as 3″ (also referred to herein as a second use configuration) or 3″′ (also referred to herein as a first use configuration), to raise or lower the mesh 4 as needed. In this manner, the heat used to cook the food may be controlled.

In various embodiments and configurations, including but not necessarily limited to the griddle configuration, the windscreen configuration, the standalone configuration, and the fire pit configuration, the legs 3 may be adjusted, at any time and as needed, to adjust the height of the grate 2 relative to the fire underneath. In this manner, regardless of what configuration is in use, the intensity of heat applied to the food may be controlled and defined.

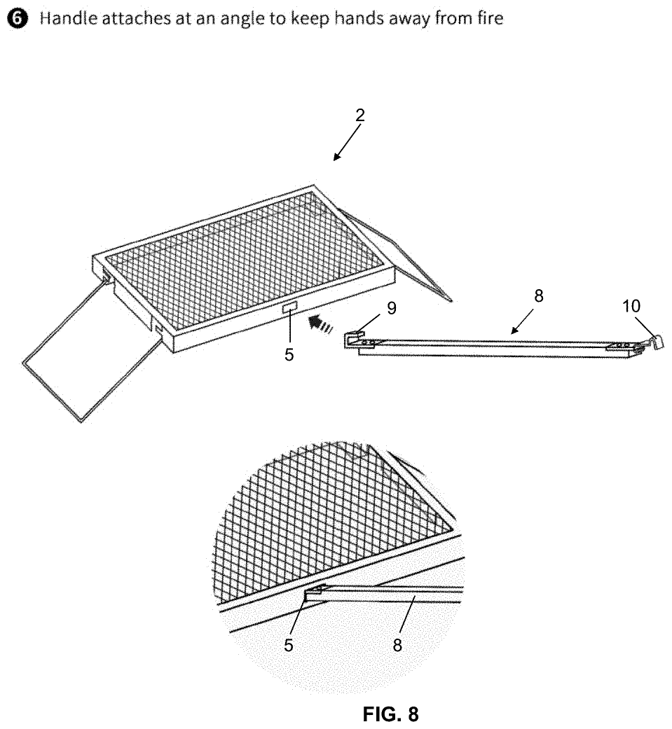

Referring now to FIG. 8, a perspective view depicts an inset of hook 9 of the handle 8 to the grate 2 opening 5. In some embodiments, the handle 8 includes a hook 9 and an angled hook 10. The hook 9 and/or the angled hook 10 may be used to hook into the grate's opening 5 of the grill device 1 such that the handle 8 can be used to hold the grate 2 as needed, for instance, when the grate 2 is hot and cannot be handled directly.

Referring now to FIG. 9, there is shown a perspective view of the grate 2 of the grill device, 1 depicting a plurality of legs 3 which may be reversibly secured in a plurality of configurations. A first configuration 3′ may be useful for the fire pit configuration of the grill device 1, and the other two configurations 3″ and 3″′ may be useful for the fire pit configuration and other use configurations of the grill device 1, including but not necessarily limited to the griddle configuration, the windscreen configuration, and the standalone configuration. The distance between the grate 2 and the fire thereunder would be greater with the 3″′ configuration and lesser with the 3″ and the 3′ configuration, as would be understood by a person having ordinary skill in the art.

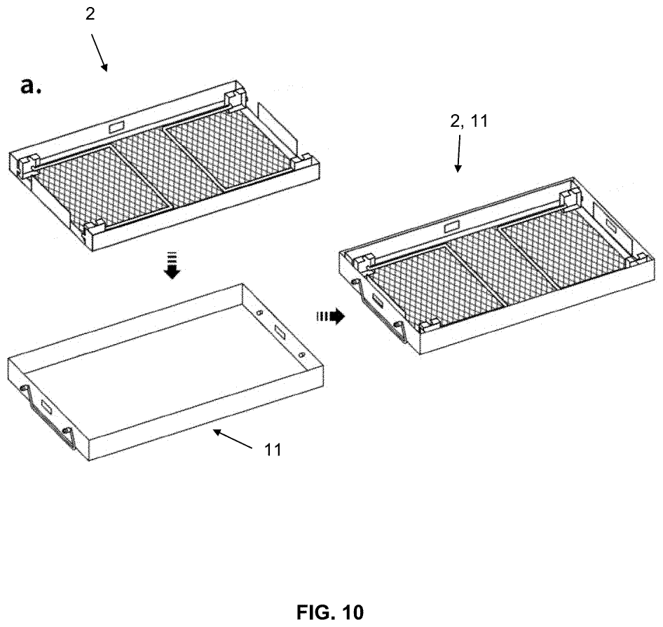

Referring now to FIGS. 10 and 11, perspective view is depicted of placement of the grate 2 into the cover 11 (FIG. 10), thereafter a user reversibly attach the handle 8 to openings 14 of the cover 11 to secure the grate's placement in the cover 11 (FIG. 11). By inserting the grate 2 into the cover 11 and securing the grate 2 in place with the handle 8, the grill device 1 may be configured as a compact unit for storage or transport. The hook 9 and the angled hook 10 of the handle 8 are designed to hook into opposite cover openings 14 of the cover 11, respectively, as shown.

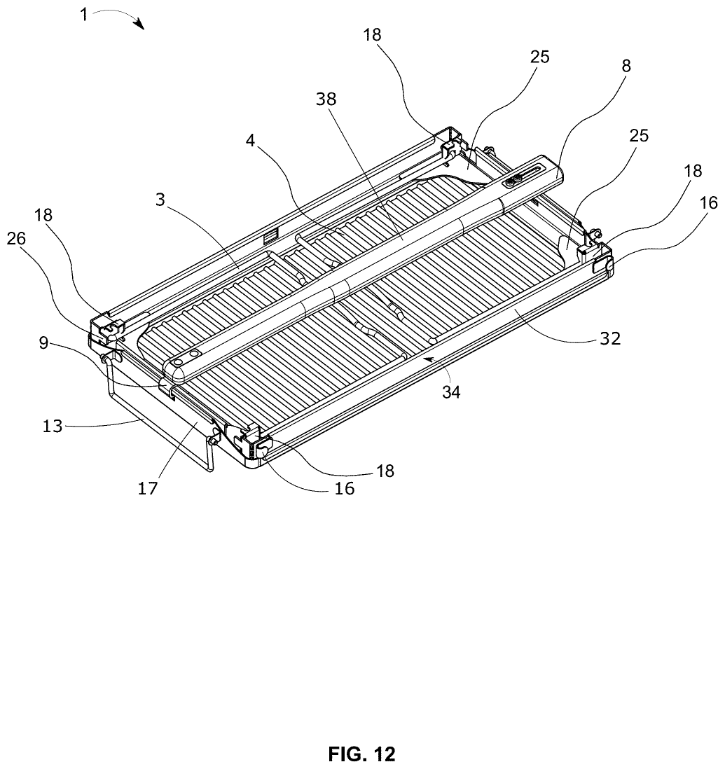

FIGS. 12 to 15C illustrate another embodiment of the presently disclosed grill device 1. FIG. 13 depicts components of the grill device 1 including a handle 8, a grate frame 34, a mesh 4, and a cover 11. The handle 8 includes an elongated rod 38, and hook 9 and spring-operated hook 19 on its first and second ends, respectively. In the presently described embodiment, grate 2 comprises two separable parts, a grate frame 34 and a mesh 4. The grate frame 34 generally comprises a frame comprising side walls 32, grip ridges 17, a plurality of legs 3 (depicted in a storage/transport configuration), leg securement mechanism 6 which comprises pivot lock 18, and a plurality of corner braces 25. In the embodiment shown, the grate frame 34 is substantially rectangular and comprises two parallel side walls 32 and two parallel grip ridges 17, whereas side walls 32 are the longer sides of the rectangle. In some embodiments, the grill frame 34 comprises four corner braces 25, one in each corner of the grate frame 34. One of the side walls 32 comprises opening 5, whereas the other, parallel, sidewall 32 comprises clips 16. Each of the two grip ridges comprises opening 35. Finally, the cover 11 includes a base 12 with a ridge/side wall 15 which extends upward around an outer perimeter of the base 12. In the embodiment shown, the cover 11 is substantially rectangular and designed for the grate 2 to fit inside it when the grill device is 1 in a compact configuration. On the two shorter sides of the cover 11, the ridges 15 comprise grips 13 and openings 14. The mesh 4 which may be of any design or pattern suitable for a grill mesh 4, is intended for food to lay on it and to be grilled on it, and is designed to fit in the grate frame 34. When the mesh 4 is fitted in the grate frame 34, for example, when the grill device 1 is in use or prepared for use, it lays securely upon the corner braces 25. Conveniently, the mesh 4 can be removed from the frame grate 34 as desired, for example, for the purpose of cleaning it or replacing it with a different mesh $.

FIG. 12 depicts the presently disclosed grill device 1 in a storage/transport configuration. The mesh 4 lays inside the cover 11 upon surface 12. The grate frame 34 is fitted inside the cover 11 and around the perimeter of the mesh 4. In some embodiments in this configuration, openings 35 and 14, on the two shorter parallel sides of the grate frame 34 and cover 11, respectively, overlap. The handle 8 secures the grate 2 inside the cover 11 via hook 9 which is inserted through openings 14 and 35 on one side of the cover 11 and frame grate 34, and spring-operated hook 19 which is inserted through openings 14 and 35 on the other, parallel, side of the cover 11 and frame grate 34, thus the handle 8 reversibly and securely locks the cover 11, mesh 4, and grate frame 34 together. Grips 13 can then be used, as desired, for handling and easily carrying the grill device 1.

FIGS. 14A-C illustrate the grate 2 in a ready for use configuration depicting possible configurations of the legs 3. FIGS. 14A and 14B illustrate a standalone configuration of the grill device 1, while FIG. 14C depicts a fire pit configuration. In some embodiments (shown), the grate 2 comprises two legs 3, each shaped substantially as a U. In some embodiments, each leg 3 comprises two substantially parallel portions and a portion in between (referred to herein as the base of the leg 3) connecting them together. In the embodiment shown, each leg 3 is pivotally attached, via its two ends (i.e., end of the two parallel portions), to the corners of the grate frame 34 which are on each side of the grip ridge 17. FIG. 14A illustrates the grate 2 with the legs 3 secured in configuration 3″ and side wall 32 comprising opening 5 shown. In some embodiments, the U shape of each leg 3 comprises at least two substantially right angles, the right angles defining the intersections of each parallel portion with the base of the leg 3. In some embodiments, the base of the leg 3 is substantially straight and is designed to be positioned on a surface, such as the ground or a fire pit structure. FIG. 14B illustrated the grate 2 grate 2 with the legs 3 secured in configuration 3″′ and side wall 32 comprising opening 5 shown, while in FIG. 14C the legs 3 are secured in configuration 3′ and the grate is ready for use over a fire pit having a fire pit construction 7.

Referring now to FIG. 14D, the grate is illustrated with the legs 3 secured in a 3″ configuration and being reversibly attached to the handle 8 via hook 9 which is inserted in opening 5. A portion, 14E, of the grate frame 34 which comprises a leg securement mechanism 6 is depicted. In the embodiment shown, the grate frame 34 comprises four leg securement mechanisms 6, one in each corner of the grate frame 34, each leg securement mechanism 6 is pivotally attached to an end of leg 3. An embodiment of a leg securement mechanism 6 is detailed in FIG. 14E. In some embodiments, the leg securement mechanism 6 comprises pivot lock 18 which comprises a plurality of ridges and depressions (also referred to herein as grooves), as will be discussed below, which allow the legs 3 to be reversibly secured in several pre-determined configurations. In some embodiments, the pivot lock 18 comprises an opening (not shown) into which an end of the legs 3 is pivotally secured, thus allowing the legs 3 to pivot, or hinge, about a pivot point 24. In some embodiments, the end of the legs 3, which is pivotally secured to pivot lock 18, comprises a short leg 3 portion (not shown) which is at a right angle in relation to the parallel portion of the leg 3. In some embodiments of the short leg 3 portion which is pivotally attached to pivot lock 18, a first end is proximal to a parallel leg 3 portion and a second end is positioned in between the pivot lock 18 and side walls 32. Further, in some embodiments, the second end of the short leg 3 portion, comprises a ridge, or otherwise a wider portion, which prevents the short leg 3 portion from passing through the opening in the pivot lock 18 and detaching from it. This is beneficial, for example, when a user changes the configuration of the legs 3, as will be further discussed below.

The leg securement mechanism 6 is exemplified in FIG. 14E, when the legs 3 are in a storage/transport configuration, as exemplified in at least FIG. 13, a portion of the legs is secured on groove 22. In order to change the position of the legs 3 from a storage/transport configuration to configuration 3″′, a user has to slide the legs 3 toward groove 23. A user may accomplish this by holding the base of the leg 3 and pull it away from the grate frame's 34 side walls 32 or corner braces 25 until the leg 3 snaps/fits into groove 23. Once a portion of the legs 3 is positioned in groove 23, the legs are secured in the 3″′ configuration. Generally, when the legs are in the 3″′ configuration, the parallel portions of the legs 3 is at substantially 90 degrees angle in relation to the bottom of the corner braces 25. To switch the legs 3 from configuration 3″′ to configuration 3″, a user must press the two parallel sides of the U-shaped leg 3, for example, the portions thereof proximal to the pivot locks 18, toward each other, thus allowing the portion of the leg 3 to exit groove 23, pivot the legs to groove 33, and release the press thus allowing the leg 3 to regain its shape and therefore allowing a portion of the leg 3 to be secured in groove 33. Generally, when the legs are in the 3″ configuration, the parallel portions of the legs 3 is at substantially 135 degrees angle in relation to the bottom of the corner braces 25. Finally, to switch the legs 3 from configuration 3″ to configuration 3′, a user has to press the two parallel sides of the U-shaped leg 3 toward each other, for example, the portions thereof proximal to the pivot locks 18, thus allowing the portion of the leg 3 to exit groove 33, pivot the leg 3 to groove 30 while passing the it over ridge 26, and then release the press, thus allowing the leg 3 to regain its shape and therefore allowing a portion of the leg 3 to be secured in groove 30. Generally, when the legs are in the 3′ configuration, the parallel portions of the legs 3 are substantially horizontal, or substantially in a straight angle, in relation to the bottom of the corner braces 25. In some embodiments, moving the leg 3 from a folding configuration to a 3″′ configuration also necessitate a press of the leg 3 parallel sides toward each other as described. In some embodiments, the leg 3 either snaps or clips into a chosen groove 22, 23, 33, 30 a friction fit or a sized fit. Generally, as the leg 3 is within a chosen groove 22, 23, 33, 30, it is locked in place and cannot pivot freely, and as a result, the grate 2 is held at a particular height created by use of that chosen groove 22, 23, 33, 30. In some embodiments, the parallel portions of each legs comprise an outward spring force pushing them away from each other, this force presses the portion of the leg 3 inserted in a groove 22, 23, 33, 30 towards the groove, and thus reversibly secures the chosen configuration of the leg 3. While the exemplary leg securement mechanism 6 involves pivot lock 18, other leg securement mechanisms 6 may be used without departing from the scope of this disclosure.

FIGS. 14F and 14G illustrate the grate 2 attached to handle 8. In some embodiments, the handle 8 includes a hook 9 and a spring-operated hook 19. In some embodiments, the hook 9 and/or the spring-operated hook 19 may be used to hook into the grate frame 34 opening 5 of the grill device 1 such that the handle 8 can be used to hold the grate 2 as needed, for instance, when the grate 2 is hot and cannot be handled directly. FIG. 14G is bottom perspective view and a portion of hook 9 which is passed through opening 5, thus reversibly securing the grate 2 to the handle 8, is illustrated.

Moving now to FIGS. 14H and 141, The grill device 1 is depicted in a windscreen configuration. The grips 13 are reversibly secured to clips 16, such that the cover 11 is secured in an upright configuration relative to the mesh 4. The cover 11 acts to block wind, rain, etc. and thus prevents weather elements from extinguishing the fire or from displacing heat generated from the fire. In this manner, the grill device 1 may be used with the windscreen functionality, as depicted, to maintain use even in the presence of high winds or inclement weather. In some embodiments, the grips 13 either reversibly snap or reversibly clip into clips 16 and stay securely in place, and thus the cover may be positioned at a chosen vertical height relative to the mesh 4.

FIG. 14J depicts the grate 2 and cover 11 in a standalone configuration. In the configuration illustrated, the cover 11 may be used to hold fuel, which for example may be placed on surface 12 (e.g., wood, wood pellets, charcoal, etc.) therein and in this configuration, the legs 3 may be secured in a 3″ configuration to be placed on either side of the cover 11. In this manner, the grill device 1 may not need a separate source of heat, for example, as may be provided from a fire pit or ground fire.

In the embodiment depicted in FIG. 14K, the cover 11 is positioned over the grate 2 and thus configured for use as a griddle (see also the griddle configuration in FIG. 4). The cover 11 includes opening 14 for receiving hook 9 therein, so that a user can reversibly attach the cover 11 to the handle 8 and move, and manipulate the cover 11, even when cover 11 is hot from being over a fire, using the handle 8. The cover 11 may be used as a serving platter, for example, as part of a campsite or a beach cookout. In some embodiments of this configuration, the grip ridges 17 receive the grips 13 of the cover 11 to secure the cover 11 to the grate 2.

Alternatively, the cover 11 may be place on the grate in an “top side down” configuration, whereas surface 12 is proximal to the mesh 4, as illustrated in FIG. 14. In this configuration, a user may use the cover 11 as a griddle or as a cover for foods, prepared or ready to be cooked, which are placed on mesh 4. In the configuration of FIG. 14L, openings 35 and 14 overlap, allowing a user to reversibly attach hook 9 to both grate frame 34 and cover 11 simultaneously, and move or manipulate both, as desired, using handle 8. Therefore, the configuration of FIG. 14L allows a user to keep food placed on mesh 4 as if in a closed box. This can be useful, for example, for keeping food from insects/animals or keeping cooked food hot. In some embodiments of this configuration, the grip ridges 17 receive the grips 13 of the cover 11 to secure the cover 11 to the grate 2.

FIGS. 15A and 15B illustrate a top perspective view and a bottom perspective view, respectively, of an example of the presently disclosed handle 8. In some embodiments, the handle 8 of the grill device 1, includes an elongated rod 38 which comprises a hook 9 and spring-operated hook 19 on a first end and a second end thereof, respectively. Hook 9 is secured to the elongated rod 38 using any applicable attachment means 27 known in the art, such as, without limitation, screws, rivets, or nails. In some embodiments, the attachment means 27, such as rivets 27 is used on a portion of the rod 38 which is protected by a plate (shown), for example, a metal plate, to prevent the rivets 27 from splitting or otherwise deteriorating/damaging the rod 38 of the handle 8. This is especially important in the embodiment according to which the rod 38 of the handle 8 is fashioned of wood. In the example illustrated, the second end of the handle 8 comprises a spring-operated hook 19. The hook is operated by pins 29, which may be pushed toward the end of the handle 8 along a channel 37 by a user. In some embodiments, metal plate 28 covers, partially (shown) or entirely, the portion of the rod 38 which comprises the channel 37 and pins 29. The metal plate 28 serves to protect the rod 38 of the handle 8 from deterioration/damage as the spring-operated hook 19 is used by the user. It also defined the channel 37 and the position of the pins' 29 heads above the surface of the rod 38.

Finally, FIG. 15C depicts a partial sectional view of the handle 8. Attachment means 27, used in the example shown along with a plate, secures hook 9 to a first end of the handle 8. The second end of the handle comprises spring-operated hook 19. In some embodiments, the spring 20 is positioned in space 36 of the handle 8 and extends to cover a portion of the hook 19 (shown). The spring 20 is held in position by the structure of spring-operated hook 19 and by the confinement of space 36 which is designed to securely fit the spring 20, while allowing compression of the spring 20. In some embodiments, space 36 is closed, on its end which is distal to the spring-operated hook 19, with plug 31. When the user slides pins 29 in channel 37 towards the end of the handle 8 by pushing the top of the pins 29, the spring 20 compresses, plate 21 is pushed forward and in turn pushes the spring-operated hook 19 toward the end of the handle, and thus increasing the distance between hook 9 and spring-operated hook 19. When the user releases the pins 29, spring 20 recoils as possible (discussed below), and spring-operated hook changes its position accordingly. Spring-operated hook 19 is useful for an easy and convenient packaging of the grill device 1 in a storage/transport configuration (as depicted in FIG. 12). For example, to secure the grate 2 inside the cover 11 using handle 8, a user would first insert hook 9 into openings 14, 35 on a first side of the cover 1, then push, as described, the spring-operated hook 19 forward (toward the end of handle 8), thus increasing the distance between it and hook 9, and enabling to easily insert spring-operated hook 19 into openings 14, 35 on a second side of the cover 11. Once the user then releases the pins 29, spring 20 recoils as much as possible thus securing, by spring force, the spring-operated hook's 19 reversible attachment to opening 14. In order to detach the handle 8 from the cover 11, the user slides the pins 29 forward as described, thus pushing the spring-operated hook 19 toward the end of the handle 8 and increasing the distance between it and hook 9, and thus enabling to easily remove the spring-operated hook 19 from openings 14, 35 on the second side of the cover 11. Hook 9 can then be easily detached from openings 14, 35 on the first end of the cover 11, and the grill device 1 can be configured for use.

In any embodiment, any of the components/parts/elements of the grill device 1 may be combined as suitable, or desired, for the construction or use of the grill device 1. In any embodiment, any of the components/parts of the grill device 1 may be manufactured or comprised of any suitable materials known in the art, including, but not limited to, for cooking food, such as thermally conductive materials. Suitable materials include, for example, metal, metal alloys, wood, plastic, or combinations thereof, etc. The handle, and/or any component thereof, may be comprised of any suitable material, such as thermally conductive material or a thermally insulative material, for instance, as needed to prevent heat from transferring from the fire to the user's hand when they use the handle. Generally, suitable materials for fashioning the handle 8 and/or components thereof include, without limitation, metal, metal alloys, wood, plastic, or combinations thereof, etc.

In any embodiment, the disclosure provides kits comprising a grill device 1. Such kits may be comprised of other items, including but not limited to instructional materials, as may be need to assist a user with setting up and using the grill device.

The foregoing descriptions of specific implementations have been presented for purposes of illustration and description. They are not intended to be exhaustive or to limit the invention to the precise forms disclosed, and modifications and variations are possible in view of the above teaching. The exemplary implementations were chosen and described to best explain the principles of the invention and its practical application, to thereby enable others skilled in the art to best utilize the invention and its implementations with modifications as suited to the use contemplated.

It is therefore submitted that the invention has been shown and described in the most practical and exemplary implementations. It should be recognized that departures may be made which fall within the scope of the invention. With respect to the description provided herein, it is submitted that the optimal features of the invention include variations in size, materials, shape, form, function, manner of operation, assembly, and use. All structures, functions, and relationships equivalent or essentially equivalent to those disclosed are intended to be encompassed by the invention.

I claim:

1. A grill device, the grill device comprising:
a substantially rectangular grate designed for grilling food thereon;
a substantially rectangular cover, the cover comprises a substantially flat base with side walls which extend upward and around an outer perimeter of the base;
a handle, the handle comprises an elongated rod which comprises a first end and a second end, wherein the first end and the second end each comprise a hook; and,
wherein the grate is designed to fit in the cover when positioned on the flat base.

2. The grill device of claim 1, wherein the grate comprises a substantially rectangular grate frame and a substantially rectangular mesh designed for grilling food thereon.

3. The grill device of claim 2, wherein the grate frame comprises a plurality of legs, side walls along the long sides of the substantially rectangular grate frame, side walls along a central portion of each of the short sides of the substantially rectangular grate frame, four pivot locks each positioned in a corner of the grate frame, four substantially flat corner braces each positioned in a corner of the grate frame, and wherein each corner brace has a top side and a bottom side.

4. The grill device of claim 3, wherein the mesh is designed for a removable fit in the grate frame when positioned upon the top side of the corner braces.

5. The grill device of claim 4, wherein the legs are pivotally attached to the pivot locks.

6. The grill device of claim 5, wherein the grate frame comprises two U-shaped legs, and wherein each end of the U-shaped leg is pivotally attached to a pivot lock positioned on a corner on each end of a short side of the substantially rectangular grate frame.

7. The grill device of claim 6, wherein each pivot lock comprises a plurality of ridges which define grooves therebetween, wherein a user can pivot each leg as desired, and reversibly secure it, in a chosen groove, and wherein each groove defines a pre-determined configuration of the leg pivotally attached to the pivot lock.

8. The grill device of claim 7, wherein an outward spring force pushes the two parallel portions of each the U-shaped leg away from each other, and wherein to pivot the leg to a chosen groove, a user presses the two parallel portions of the U-shaped leg towards each other, thus decreasing the distance between them and allowing them to be passed over ridges as required and be securely and reversibly positioned in a groove chosen by the user.

9. The grill device of claim 8, wherein the legs can be reversibly secured in a plurality of pre-determined configurations, wherein the pre-determined configurations include a storage/transport configuration, a first use configuration, a second use configuration, and a third use configuration.

10. The grill device of claim 9, wherein in the storage/transport configuration the legs are proximal to, and substantially parallel with, the bottom side of the corner braces, wherein in the first use configuration the legs are at substantially 90 degrees angle in relation to the bottom of the corner braces, wherein in the second use configuration the legs are at substantially 135 degrees angle in relation to the bottom of the corner braces, and wherein in the third use configuration the legs are at substantially 180 degrees angle in relation to the bottom of the corner braces.

11. The grill device of claim 10, wherein the cover comprises two U-shaped handles, each handle positioned on the outside of the side wall of a short side of the substantially rectangular cover, wherein when the cover is placed upon the grate and the short sides of the cover are above the short sides of the grate, a user can securely and reversibly position the handles around the side walls of the short sides of the grate frame and thus reversibly securing the cover to the grate.

12. The grill device of claim 11, wherein the side wall along a first long side of the substantially rectangular grate frame comprises two clips, wherein a first clip is positioned substantially at one end of the said side wall and a second clip is positioned substantially at a second end of the said side wall.

13. The grill device of claim 12, wherein a user can reversibly secure the cover to the grate frame in a windscreen configuration, wherein in a windscreen configuration the substantially flat base of the cover is in an upright position relative to the mesh positioned in the grate frame, and wherein in the windscreen configuration one of the cover's handle is reversibly attached to the first clip and the cover's other handle is reversibly attached to the second clip.

14. The grill device of claim 13, wherein the side wall along a second long side of the substantially rectangular grate frame comprises an opening, wherein the opening is designed to receive the hook positioned on either the first end or the second end of the handle, and wherein when the said hook is inserted to the said opening the grate frame is reversibly and securely attached to the handle.

15. The grill device of claim 14, wherein each side wall of each of the two short side of the cover comprises a centrally positioned opening, and wherein each side walls of the short sides of the grate frame comprises a centrally positioned opening, and wherein said openings are designed to receive the hook positioned on either the first end or the second end of the handle, and wherein when the grate frame is positioned inside the cover such that the short sides of the cover are proximal to the short sides of the grate, said openings of the grate frame and cover on each said short sides overlap.

16. The grill device of claim 15, wherein the grill device is in a compact/transport configuration and wherein when in a compact/transport configuration the grate is positioned inside the cover within the perimeter of the cover's side walls; and wherein the handle reversibly secures the grill device is in a compact/transport configuration by a reversible attachment of the hook on the first end of the handle to the overlapping openings of the grate frame and cover on one side and a reversible attachment of the hook on the second end of the handle to the overlapping openings of the grate frame and cover on the other side.

17. The grill device of claim 16, wherein the hook on the second end of the handle is a spring-operated hook, wherein when a user can slide the spring-operated hook in the direction of the second end of the handle and away from the first end, the distance between the hook on the first end of the handle and the spring-operated hook increases.

18. The grill device of claim 17, wherein a user configures the grill device to a compact/transport configuration and wherein after reversibly attaching the hook of the first end of the handle to the openings of the grate frame and cover on one side of the grill device, a user uses the spring-operated hook on the second end of the handle to attach the handle easily and reversibly to the openings of the grate frame and cover on the other side of the grill device.
